(19) United States
(12) Patent Application Publication
(10) Pub. No.: US 2012/0251133 A1
(43) Pub. Date: Oct. 4, 2012

(54) IMAGE FORMATION SYSTEM, METHOD FOR IMAGE FORMATION AND RECORDING MEDIUM

(75) Inventor: Yukihiro Shindo, Kawasaki-shi (JP)

(73) Assignee: CANON KABUSHIKI KAISHA, Tokyo (JP)

(21) Appl. No.: 13/431,490

(22) Filed: Mar. 27, 2012

(30) Foreign Application Priority Data
Mar. 28, 2011 (JP) 2011-070246

(51) Int. Cl. G03G 13/00; G03G 15/00

(52) U.S. Cl. 399/21

(57) ABSTRACT

An image formation system wherein a paper discharge unit of a first image formation device which forms an image using a colored printing agent, is connected with a first paper feeder of a second image formation device which forms an image using a transparent printing agent, and a printing material formed by the first image formation device is fed to the second image formation device, the image a formation system comprising: a jam detector; and an image formation unit that, when detecting a jam in the second image formation device, causes a printing material to be fed to the second image formation device from a second paper feeder separate and causes the second image formation device to form an image upon detecting a jam in the second image formation device, and second image data inputted together with the first image data using colored and transparent printing agents.

### BACKGROUND OF THE INVENTION

1. Field of the Invention

The present invention relates to an image formation system, method for image formation and recording medium that executes the printing method, and particularly to an image formation system with a plurality of image formation devices, method for image formation and recording medium.

2. Description of the Related Art

Typically, a printing system that connects the paper discharge unit and paper feeders of a plurality of printers in order to complete one printing job is currently used for spot color printing and double-sided printing. In recent years, this kind of printing system is also used for special toner printing. For example, in a printing system wherein one printer transfers and fixes CMYK toner and clear toner, which is one kind of special toner, problems occur related to the amount of toner used. More specifically, in an image processor, there is a limit to the amount of toner that can be fixed at one time per unit area of the paper on which printing is to be performed. Therefore, in an area where a lot of CMYK toner is used, there is a problem in that, in order to keep the amount of toner used within the limited amount, a sufficient amount of clear toner cannot be used.

Therefore, creating an image processing system that creates an output image using clear toner by connecting an image processor that performs printing using colored toner and an image processor that performs printing using clear toner has been proposed (for example, refer to Unexamined Japanese Patent Laid-Open No. 2008-145595). In other words, of the two printers, a first printer transfers and fixes CMYK toner to the paper, and then a second printer transfers and fixes clear toner to the paper on which CMYK toner has been printed. That is, paper that is discharged from the first printer is fed to the paper feeder of the second printer, so that high-quality printing becomes possible by using two printers and using sufficient amounts of toner.

Moreover, when performing double-sided printing using one printer, it is necessary to turn the paper over after the top side has been printed, and it is difficult to achieve high-speed printing, so that it is possible to use a printing system wherein two printers are connected. In other words, the first printer of this printing system prints an image on the top surface of the paper, and after printing is completed, the second printer prints an image on the rear surface of the paper. That is, by feeding the paper that is discharged from the first printer to the paper feeder of the second printer such that the rear surface is turned over, it becomes possible to perform high-speed double-sided printing without having to stop the printing flow. By creating a system wherein two printers are connected in this way, a system that meets the needs of the user is created.

In this kind of printing system, when a jam, such as a paper jam, occurs in the second printer and printing has to be performed again from the start, the printed paper remaining in the second printer for which printing by the first printer has been completed must be discarded. For example, normally, there is large number of sheets of paper (for example, sheets) located between the first and second printers. Here, for example, when the second printer is printing an image on the 15th sheet of paper, the first printer has already printed an image on the 35th sheet of paper. At this time, when a jam occurs in the second printer, even though the first printer has already printed 20 sheets, printing has to be performed again from the 15th sheet of paper. Therefore, the 20 sheets from the 15th sheet that have already been printed by the first printer must be discarded. A printing system that keeps waste of paper to a minimum when this kind of jam occurs has been proposed wherein pages to be reprinted by the second printer are identified in consideration of the pages for which printing by the first printer has been completed (for example, refer to Unexamined Japanese Patent Laid-Open No. 2003-397

However, in a conventional system that completes one printing job by connecting the paper discharge unit and the paper feeder of a plurality of printers, reprinting because of a jam is set as an auxiliary printing job, so that pages that are reprinted are printed at the end as additional printing. Therefore, it is possible to reduce the amount of wasted paper; however, there is a problem in that the order of the printed pages differs from the original order.

The object of the present invention is to reduce the amount of wasted paper, while at the same time maintaining the proper page order when a jam occurs in the second printer.

### SUMMARY OF THE INVENTION

The image formation system of the present invention including a first image formation device for forming an image according to first image data of inputted image data using a colored printing agent and a second image formation device forms an image according to second image data of the inputted image data using a transparent printing agent wherein a paper discharge unit of the first image formation device is connected with a first paper feeder of the second image formation device, configured to supply a printing material on which an image was formed by the first image formation device to the second image formation device, provides: a jam detector for detecting that a jam occurs in the second image formation device; and an image formation unit for, if the jam detector detects that a jam has occurred in the second image formation device, causing the first image formation device to feed a printing material to the second image formation device from a second paper feeder that is different from the first paper feeder, and causes the second image formation device to form an image according to first image data formed on the printing media upon detecting a jam in the second image formation device, and second image data of the image data, which was inputted together with the first image data, using colored printing agent and transparent printing agent.

In a printing system that completes printing by physically connecting printers, when data that could not be printed properly due to a jam that occurred in the subsequent printer is reprinted after that jam has recovered, it was not possible to maintain the printing order.

However, in the present invention, when recovering from a jam, it is possible to suppress wasteful use of printing paper by using paper during reprinting without discarding paper that has been printed on and is backed up in a former stage and without changing the printing order.

Further features of the present invention will become apparent from the following description of exemplary embodiments (with reference to the attached drawings).

### DESCRIPTION OF THE DRAWINGS

FIG. 1 is a system configuration diagram of an embodiment of the present invention;

FIG. 2 is a view showing a relationship between FIG. 2A and FIG. 2B;

FIG. 2A is a drawing illustrating the system configuration 1 of an embodiment of the invention;

FIG. 2F is a drawing illustrating the system configuration 1 of an embodiment of the invention;

FIG. 3 is a drawing illustrating an example of the processing flow during normal printing;

FIG. 4 is a drawing illustrating the operation when a jam occurs in a first MFP of an embodiment of the invention;

FIG. 5 is a drawing illustrating an example of a warning screen;

FIG. 6 is a drawing illustrating an example of a warning screen and an inquiry of whether to continue printing;

FIG. 7 is a view showing a relationship between FIG. 7A and FIG. 7B

FIG. 7A is a drawing illustrating system configuration 2 of an embodiment of the invention;

FIG. 7B is a drawing illustrating system configuration 2 of an embodiment of the invention;

FIG. 8 is a drawing illustrating an example of the processing flow 1 during a jam recovery operation;

FIG. 9 is a drawing illustrating an example of operation when a jam occurred in a second MFP;

FIG. 10 is a drawing illustrating an example of the processing flow 2 during a jam recovery operation;

FIG. 11 is a drawing illustrating an example of a recovery method request screen 1;

FIG. 12 is a drawing illustrating an example of a recovery method request screen 2;

FIG. 13 is a drawing illustrating processing flow in an embodiment of the present invention when automatically determining the recovery method;

FIG. 14 is a drawing illustrating an example of a printing test screen; and

FIG. 15 is a drawing illustrating a preview of the printing test screen.

### DESCRIPTION OF THE EMBODIMENTS

In the owing, embodiments of the present invention will be explained with reference to the drawings. The case of using two printers, a color laser printer that performs printing using CMYK toner, and a color laser printer that performs printing using CMYK toner as a colored printing agent and a clear toner as a transparent printing agent, will be explained as an embodiment of the present invention. However, the scope of the present invention is not limited to this. That is, without departing from the scope of the present invention, it is possible to apply the invention to arbitrary image formation devices that can completely execute one printing job for which an instruction has been given by connecting printers having the configuration described below.

### Embodiment 1

### Explanation of the Overall Configuration

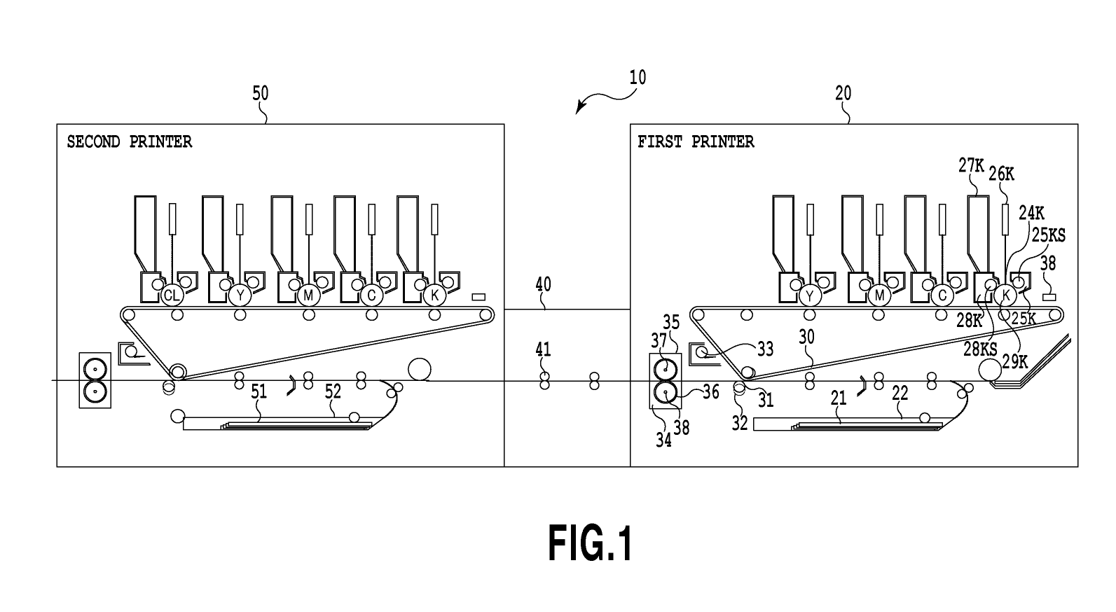

FIG. 1 is an image formation system of an embodiment of the present invention. FIG. 1 illustrates the overall configuration of a printing system 10. The printing system comprises a first printer 20 that first takes in paper 21, and a second printer 50 that receives the paper 21 that is fed from the first printer 20. An intermediate buffer 40 is located between the first and second printers. The intermediate buffer temporarily stores paper between the first and second printers. The first and second printers perform printing using a plurality of various kinds of toner; however, when the printing speeds between the two printers differs, this intermediate buffer 40 resolves the difference in printing speeds. Moreover, in this embodiment, the case is presumed wherein, when forming an image of inputted image data using a plurality of sheets of printing material, this printing material causes a jam.

Here, paper as the printing material, which has been printed on by the first printer 20, is stacked in order in the intermediate buffer 40 after printing is completed. When feeding paper that has been stacked in the intermediate buffer such that the printing order is not changed, the second printer 50 must take out the sheet of discharged paper that is on the bottom of the stacked paper. Therefore, there is a possibility that feeding the paper will not go well and a jam will occur or that sheets of paper will not be kept in the correct printing order. Therefore, in the intermediate buffer 40, timing for discharging paper and feeding paper is controlled as described below; however, control is not limited to this, and it is possible to use any method know in this technical field.

When printing by the first printer 20 ends, one sheet of paper that has been printed on using colored toner is discharged to the discharge unit, and stacked as is in the intermediate buffer 40. Next, when printing by the first printer 20 ends, before that newly printed paper is discharged to the discharge unit, the second printer 50 feeds the paper was placed in the intermediate buffer. As a result, multiple sheets of paper are not stacked in the connecting section 41. With this kind of printing system 10, paper 21 passes in succession through two printers, and in the first printer, printing is performed using CMYK toner of a plurality of colors. Next, the printing paper that is discharged from the first printer is fed to the second printer, and printing can be performed on part or the entire surface of the printing paper using clear toner. In this way, printing is performed using clear toner after color toner has been printed and fixed, so it is possible to use a sufficient amount of toner, and perform high-quality printing.

The second printer 50 has a paper feeder mechanism 52 that can feed paper for printing that is performed independently by just the second printer 50, and that is separate from the paper that is discharged from the first printer 20. In addition to this, besides performing printing using clear toner, the second printer 50 can also perform printing using CMYK toner similar to the first printer 20,

### (Explanation of the Printer)

Next, the printing operation by an electrographic type printer will be simply explained using FIG. 1. FIG. 1 is a cross-sectional view illustrating an example wherein two electrographic type printers are connected together using an intermediate buffer. The first printer 20 forms an electrostatic latent image by driving an exposure laser according to output exposure time, then develops that electrostatic latent image and forms a single-color toner image. Then, the first printer 20 forms a multi-color toner image over the single-color toner image, and after transferring that multi-color toner mage to the printing material 21, fixes the multi-color toner image to the printing material 21. Here, basically there is a separate module for each color up to development of the CMYK toner for formation of an electrostatic latent image, so that the difference in modules is represented by attaching C, M, Y or K, which indicates the color of toner, to the end of the reference number. In the following, in the case of contents that are the same for each color, the construction for one of the colors will be explained as an example.

An infusion charger 25K is used as a charging unit for charging a photoreceptor 24K. There is a sleeve 25KS provided in the infusion charger 25K. The photoreceptor 24K comprises an aluminum cylinder that is coated on the outer surface with an organic light conducting layer, and can be rotated by a driving force that is transmitted from a drive motor (not illustrated in the figure). The drive motor can rotate the photoreceptor 24K in a counterclockwise direction according to the image formation operation.

An exposure unit is such that a scanner 26K irradiates the photoreceptor 24K with exposure light, and by selectively exposing the surface of the photoreceptor 24K, forms an electrostatic latent image. The developing unit comprises a developer 28K that performs single-color development of the electrostatic latent image. There is a sleeve 28KS in the developer 28K. The developer 28K is removable. The transfer unit rotates an intermediate transfer body 30 in the clockwise direction in order to transfer the single-color image from the photoreceptor 24K to the intermediate transfer body 30. As the photoreceptor 24K and a primary transfer roller 29K that faces the photoreceptor 24K rotate, the single-color toner image is transferred.

By applying a proper bias voltage to the primary transfer roller 29K, and applying a difference between the rpm of the photoreceptor 24K and the rpm of the intermediate transfer body 30, a single-color toner image is efficiently transferred to the intermediate transfer body 30 (this is called primary transfer). In the first printer 20, units for primary transfer are prepared for yellow (Y), magenta (M), cyan (C) and black (K), however, the colors are not limited to these colors. In the second printer 50 units are also provided for clear toner (CL), which is a special toner.

For each color, a single-color toner image is superimposed onto the intermediate transfer body 30, and as the intermediate transfer body 30 rotates, the superimposed multi-color toner image is conveyed to the secondary transfer rollers 31, 32. Furthermore, printing material 21 is conveyed from the paper feeding trays 22, 23 to the secondary transfer rollers 31, 32, and the multi-color toner image that is on the intermediate transfer body 30 is transferred to the printing material 21. A proper bias voltage is applied to the secondary rollers 31, 32, and the toner image is transferred electrostatically (this is called secondary transfer). While the multi-color toner image is transferred to the printing material 21, the secondary transfer rollers 31, 32 come in contact with the printing material 21 at the position where the transfer roller 31 is located. A fixing unit comprises a fixing roller 35 that heats the printing material 21, and a pressure roller 36 for pressing the printing material 21 in contact with the fixing roller 35. The fixing roller 35 and the pressure roller 36 are hollow with a heater 37, 38 being respectively housed inside each. The fixing unit 34 applies heat and pressure as the fixing roller 35 and pressure roller 36 convey the printing material 21 that holds the multi-color toner image, and fixes the toner to the printing material 21.

After the toner is fixed, the printing material 21 is discharged by the discharge roller (not illustrated in the figure) to the discharge tray (not illustrated in the figure), and the image formation operation ends. A cleaning unit 33 for cleaning the toner remaining on the intermediate transfer body nuts the waste toner that remained after the 4-color multi-color toner image that was formed on the intermediate transfer body 30 was transferred to the printing material 21 in a cleaner container.

### (Explanation of the System Configuration)

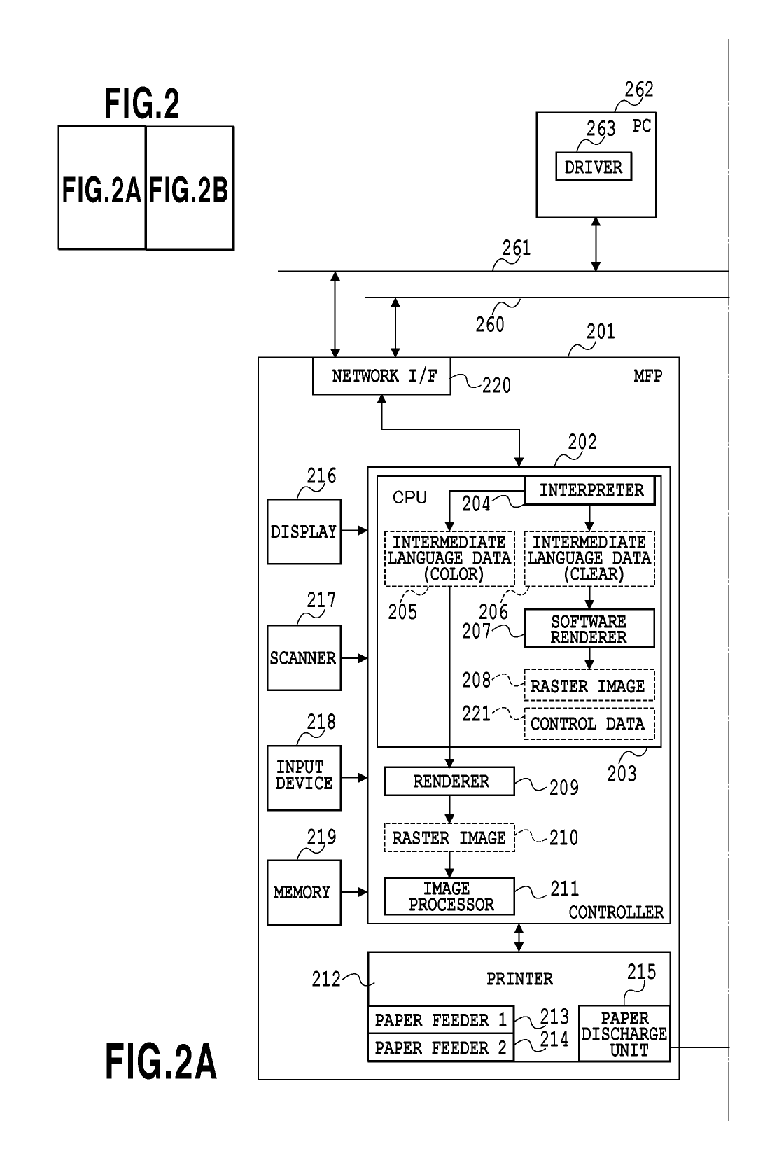

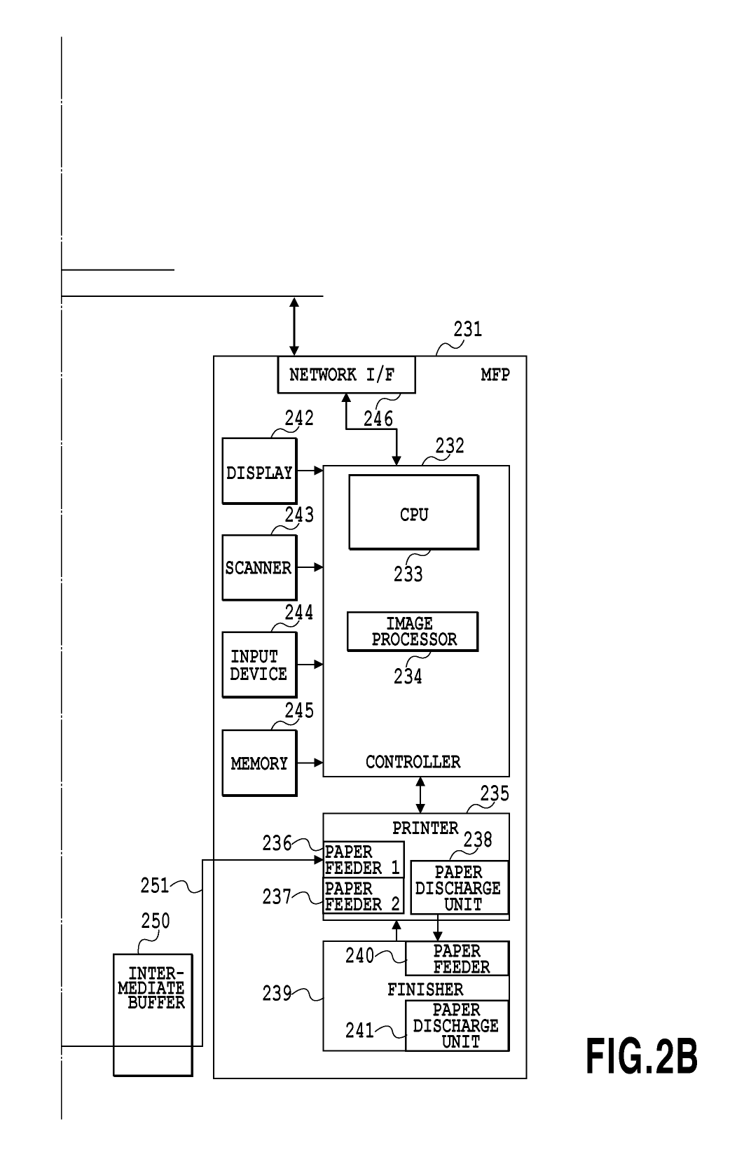

Next, FIGS. 2A and B illustrates the system configuration of this embodiment of the invention. A first MFP 201 that performs printing using CMYK toner and a second MFP 231 that performs printing using clear toner are connected via a network 260. The toner that can be used by the first MFP 201 is not limited to CMYK toner, and can be monochrome toner or the like. Similarly, the toner that can be used by the second MFP 231 is not limited to clear toner, and could be gray toner, or a special color toner such as gold or silver. Moreover, the devices of this system are not limited to MFP, and any image forming device having the construction described below can be used. Furthermore, the printer 212 in the first MFP 201 in FIGS. 2A and B correspond to the first printer 20 in FIG. 1. Similarly, the printer 235 in the second MFP 231 in FIGS. 2A and B correspond to the second printer 50 in FIG. 1. The intermediate buffer 250 in FIGS. 2A and B correspond to the intermediate buffer 40 and connecting section 41 in FIG. 1.

The paper discharge unit 215 of the first MFP 201 and the paper feeder 236 of the second MFP 231 are connected by way of the connecting section 251 and the intermediate buffer 250, and paper that is discharged from the paper discharge unit 215 of the first MFP 201 can be automatically fed by the paper feeder 236 of the second MFP 231. Here, the MFP is a device having multiple functions such as copy, printing and FAX functions in one device. Moreover, a PC 262 is connected with the first MFP 201 by way of a network 261. A driver 263 inside the PC 262 recognizes the first MFP 201 and second MFP 231 as one system that uses CMYK toner and clear toner, and sends printing data.

In the system illustrated in FIGS. 2A and B, printing using CMYK toner and clear toner is possible by one instruction. The clear toner can be printed on all sides of the paper, or during a printing process or copying process, can be printed on only specified color data or an object. The first MFP 201 that uses CMYK toner will be explained in detail. A network I/F 220 sends and receives printing data, and as will be described later sends raster images and control data. A controller 202 comprises a CPU 203, and renderer 209, and an image processer 211. An interpreter 204 of the CPU 203 interprets the PDL portion of the received printing data, and creates intermediate language data (color) 205. The intermediate language data (color) 205 is finally separated into colors for CMYK toner, images in each color are generated, and developing is performed for each color. The renderer 209 generates a raster image 210 from the intermediate language data (color) 205.

The image processor 211 performs image processing of a raster image 210 or image read by a scanner 217. The printer 212 that is connected to the controller 202 is a printer that forms output data on paper using CMYK toner. The printer 212 as a paper feeder 1_213 and paper feeder 2_214 that feed paper, and a paper discharge unit 215 that discharges paper on which an image of the output data is formed. Normally, a MFP has a paper feeder 1_213 that feeds paper that is manually set into a tray, and a paper feeder 2_214 that feeds paper this is set into a cassete tray. Moreover, the printer 212 normally has a reverse pass mechanism (not illustrated in the figure) for printing on both sides of the paper. A display 216 displays instructions to the user, and UI that indicates the state of the first MFP 201.

The scanner 217 is a scanner that includes an auto document feeder. The scanner 217 irradiates a bundle or a single original document image with light from a light source (not illustrated in the figure), forms the reflected original document image onto a solid-state image sensing device such as a CCD sensor, and obtains a raster like read image signal from the solid-state image sensing device as image data. An input unit 218 is an interface for receiving input from the user. A memory 219 stores printing data or processed data from the controller 202.

When a clear instruction is included in the printing data, the interpreter 204, in addition to generating intermediate language data (color) 205 that forms an image to be printed using CMYK toner, also generates intermediate language data (clear) 206 that forms an image to be printed using clear toner. In the following, an image that is to be printed using CMYK toner will be referred to as a CMYK image, and an image that is to be printed using clear toner will be referred to as a clear image.

Processing that uses a named profile will be explained as an example of a method for giving an instruction (clear instruction) for the area where printing using clear toner is to be performed. On the application side, when a specific character string is used when specifying the input color, a named profile that corresponds to that character string is selected. Processing that uses a “named profile” data format will be explained. When a specific character string is correlated with a certain input color using an application, the named profile that corresponds to that specific character string is selected, and it becomes possible to give a clear toner selection instruction for performing printing using clear toner for a desired portion. In other words, it becomes possible for the driver 263 of the PC 262 to specify using clear toner for that character string.

The interpreter 204 creates intermediate language data (clear) 206 by extracting only the portion specified for clear printing and creating a layer. A software renderer 207 converts the intermediate language data (clear) 206 to a raster image 208. The first MFP 201 sends the raster image 208 that was generated in this way to the second MFP 231 via a network 260. An example of using a named profile was presented as a method for giving a clear instruction; however, any method can be used as long as a clear raster image 208 is generated. Moreover, the first MFP 201 sends control data 221 to the second MFP 231 via the network 260. Here, the control, data 221 is information such as the number of sheets of paper, the paper size, the media type, page settings, finisher setting and the like that is set by the user via the driver 263

Next, the second MFP 231 that uses clear toner will be explained in detail. A network I/F 246 connects with the network I/F 220 via the network 260, and data is sent and received between the first MFP 201 and the second MFP 231 via this network I/F 246. A controller 232 has the same construction as that of the first MFP 201, and in normal printing, uses a CPU 233 and image processor 234. A printer 235 that is connected to the controller 232 is a printer that forms output data on paper using clear toner.

The printer 235 has a paper feeder 1_236 and paper feeder 2_237 that feed paper, and a paper discharge unit 238 that discharges the paper on which output data has been formed. The paper feeder 1_236 is connected with the discharge unit 215 by way of the connecting section 251 and intermediate buffer 250, and automatically feeds paper that has been discharged from the first. MFP 201. When there is a difference in the printing speeds of the first MFP 201 and the second MFP 231, the intermediate buffer 250 absorbs that difference is speed.

The paper feeder 2_237 feeds paper that has been set in the second MFP 231. The finisher 239 has functions such as sorting and stapling. The discharge unit 238 of the printer 235 and the paper feeder 240 of the finisher 239 are connected, and after processing such as sorting or stapling that was specified by the user has been performed, output is performed by using the discharge unit 241. A display 242, scanner 243, input unit 244 and memory 245 are the same as those of the first MFP 201, so explanation of them are omitted.

The second MFP 231 receives a raster image 208 and control data 221 from the first MFP 201, performs processing of the raster image 208 using an image processor 234, and controls the printer 235 and finisher 239 using the control data 221.

### (Flow of the Printing Process)

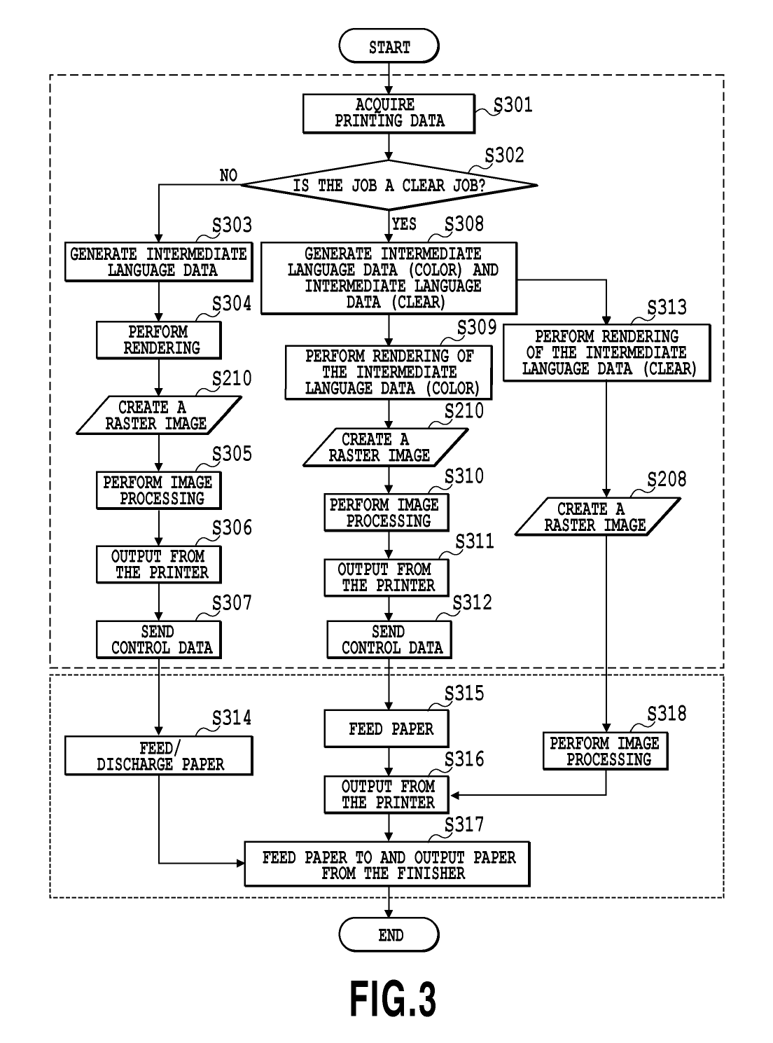

Next, FIG. 3 will be used to explained the flow when, in the system of this embodiment, the PC 262 uses the driver 263 to execute a printing process. The program for the processing from step S301, to step S313 is stored in the memory 219 of the first MFP 201, and is called by the RAM and executed by the CPU 203. The program for the processing from step S314 to step S318 is stored in the memory 245 of the second MFP 231, and is called by the RAM and executed by the CPU 233.

First, in step S301, the controller 202 acquires printing data that was sent from the PC 262. As described above, when sending printing data, by correlating the data with named profiles, the PC 262 is able to give instructions for specific colors or give clear instructions for objects.

Next, the CPU 203 references each named profile in the printing data, and in step S302, determines whether or not the job is a clear job (the job that is given the clear instructions). When the printing job is not a clear job, in step S303, the interpreter 204 creates intermediate language data (color) 205. Furthermore, in step S304, the renderer 209 performs rendering and creates a raster image 210.

In step S305, the image processor 211 executes image processing, and in step S306, the printer 212 uses CMYK toner to output image data on the printing paper. Next, in step S307, the CPU 203 sends control data 221 to the controller 232 of the second MFP 231 via the network I/F 220. In the second MFP 231, in step S314 the control data 221 is referenced and the paper feeding and paper discharging processes are performed. Here, clear toner is not used. Finally, in step S217, based on control data 221, the finisher 239 performs paper feeding and output. Here, when the control data 221 specifies a process such as sorting, the finisher 239 performs that process according to that instruction.

In step S302, when the printing job is determined to be a clear job, in step S308 the interpreter 204 creates intermediate language data (color) 205 and intermediate language data (clear) 206. Then, in step S309, the renderer 209 performs rendering of the intermediate language data (color) 205 and creates a raster image 210. Next, in step S310, the image processor 211 performs image processing, and in step S311, the printer 212 uses CMYK toner to output image data onto the printing paper. Then, in step S312, the CPU 203 sends control data 221 to the controller 232 of the second MFP 231 via the network I/F 220.

On the other hand, in step S313, the software renderer 207 performs rendering of the intermediate language data (clear) 206 and creates a raster image 208, and sends that raster image 208 to the second MFP 231. In step S315, the second MFP 231 references the control data 221 and performs paper feeding. However, in step S318, the image processor 234 performs image processing of the raster image 208. Then, in step S316, the printer 235 uses clear toner to output image data onto the fed printing paper. Finally, in step S317, based on the control data 221, the finisher 239 performs paper feeding and output. By using the first MFP 201 and second MFP 231 as described above, it becomes possible to output CMYK toner and clear toner onto the printing paper with only one instruction from the driver 263.

(Operation Flow when a Jam Occurs in the First MFP 201)

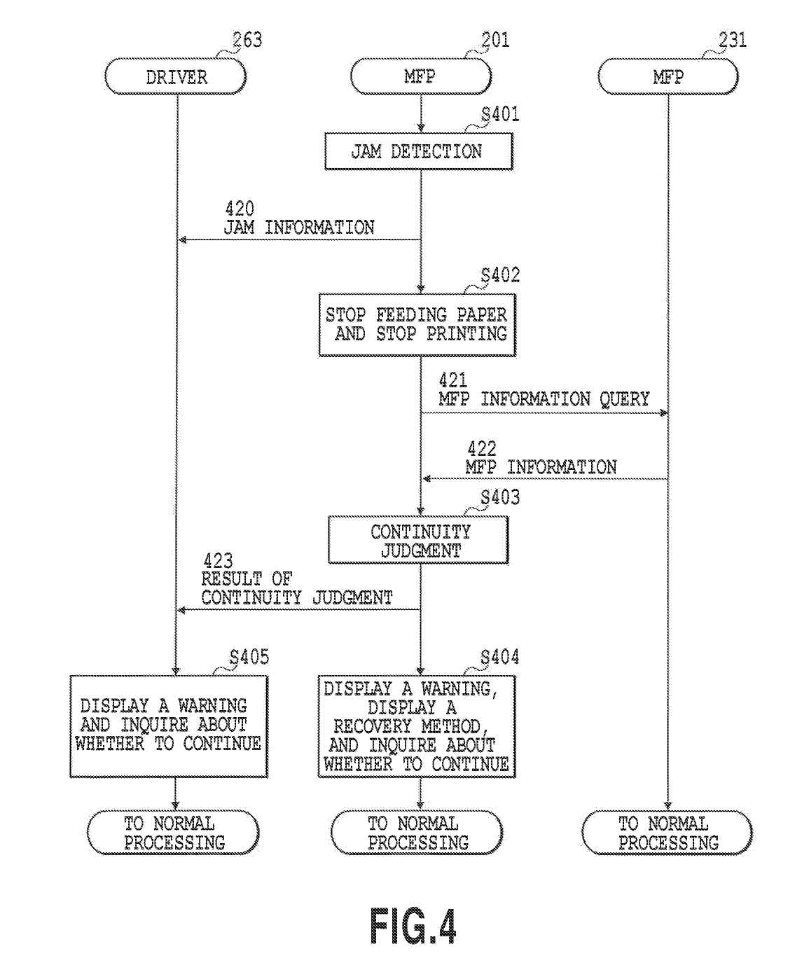

The processing performed when restoring a jam that occurs in the system of this embodiment will be explained using FIG. 4 to FIG. 6. The program for the processing from step S401 to step S404 is stored in the memory 219 of the first MFP 201, is installed in PAM and executed by the CPU 203. Moreover, the program for the processing of step S405 is stored in a memory (not illustrated in the figures) of the PC 262, is installed in RAM and executed by the driver 263 that is expanded by a CPU (not illustrated in the figures).

First, FIG. 4 illustrates the flow of operation performed when a jam occurs in the first MFP 201. In step S401, a notification is received from a jam detection sensor (not illustrated in the figures). The first MFP 201 that received the jam detection notification notifies the driver 263 of the jam information 420. In step S402, a jam detection notification is received, paper feeding and printing are stopped, a query 421 is made to the second MFP 231 for MFP information, and the MFP information 422 is received in return.

As a result, while the operator or user is taking care of the jam that occurred in the first MFP by removing paper or the like, it is possible to perform an information query in order to determine whether alternate printing by the second MFP is possible. More specifically, this query is an information query for information indicating whether or not various printing settings (monochrome printing, color printing, clear printing, double-side printing, Nin1, paper size, and the like) can be received.

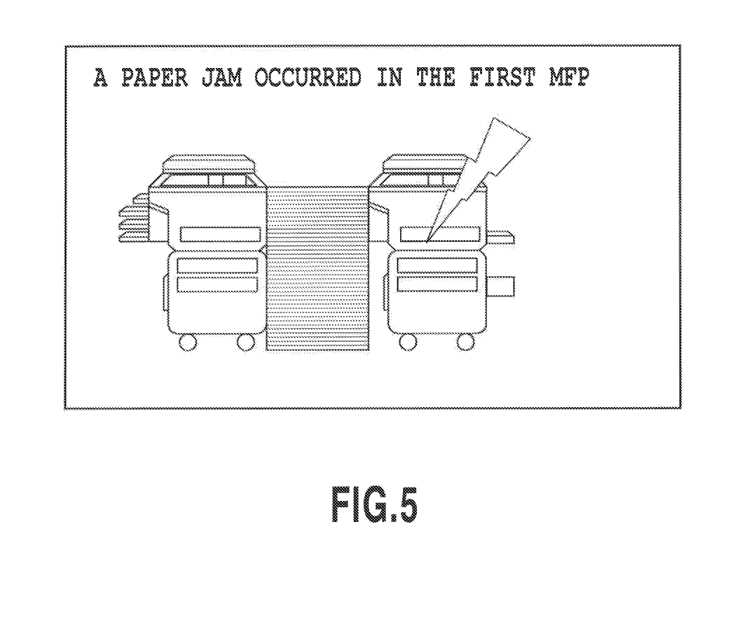

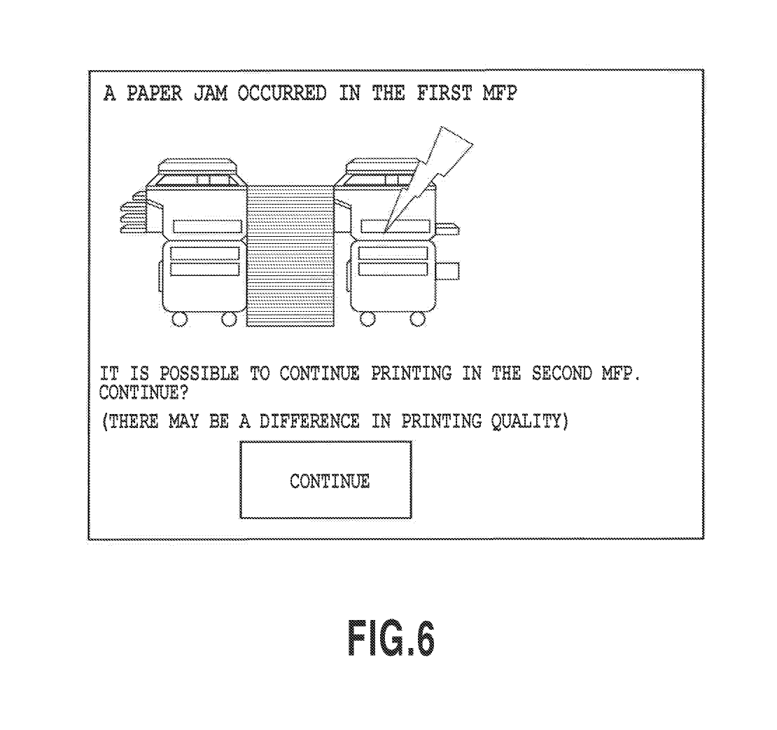

In step S403, determining whether it is possible to continue printing is performed based on the MFP information 422 received from the second MFP 231 and from job information of the currently stopped printing. The judgment result 423 of the whether continuation is possible is notified to the driver 263. The driver 263 receives the jam information 420 and continuity judgment result 423, and in step S405 displays a warning screen (for example, a warning screen as illustrated in FIG. 5) on a display (not illustrated in the figures). When the continuity judgment result 423 indicates that it has been determined that continuing printing is possible, the driver 263 displays another screen, which is not only a warning screen but is also a query screen (such as illustrated in FIG. 6) asking the operator whether to continue printing, and prompts the operator to input a decision, or in other words an instruction.

Similarly, the first MFP 201, which received a jam notification and continuity judgment result, in step S404 displays a warning screen and recovery method (location where the paper jam occurred and method for removing the paper) on the display 216. When the continuity judgment result indicates that continuing printing is possible, a query display asking whether to continue printing is also displayed. In other words a “Continue” button is displayed as illustrated in FIG. 6, and when the operator presses this button, it is recognized as a decision to continue, and processing advances.

When the driver 263 or an input device of the first. MFP 201 receives a “Continue” instruction from the operator, notification of the continue instruction is performed between the driver 263 and the first MFP 201, and the continue query display is removed.

In this embodiment, a query for MFP information and a judgment are performed when a jam occurs in order to determine whether or not it is possible to continue printing; however, processing is not limited to this. This process could also be performed at the start of a printing job. When judgment is performed based only on information about the device (for example, whether there is CMYK toner, whether there is a reverse path mechanism or the like), the process can be performed when the power is turned ON, or after a specified amount of time, or when it is detected that devices have been connected.

Moreover, in this embodiment, the operator is asked whether printing by the second MFP 231 should be continued, however, by setting beforehand the operation to be performed for when, a jam occurs, it is possible to eliminate this query.

(Operation Flow when Printing by the Second MFP 231 is Continued)

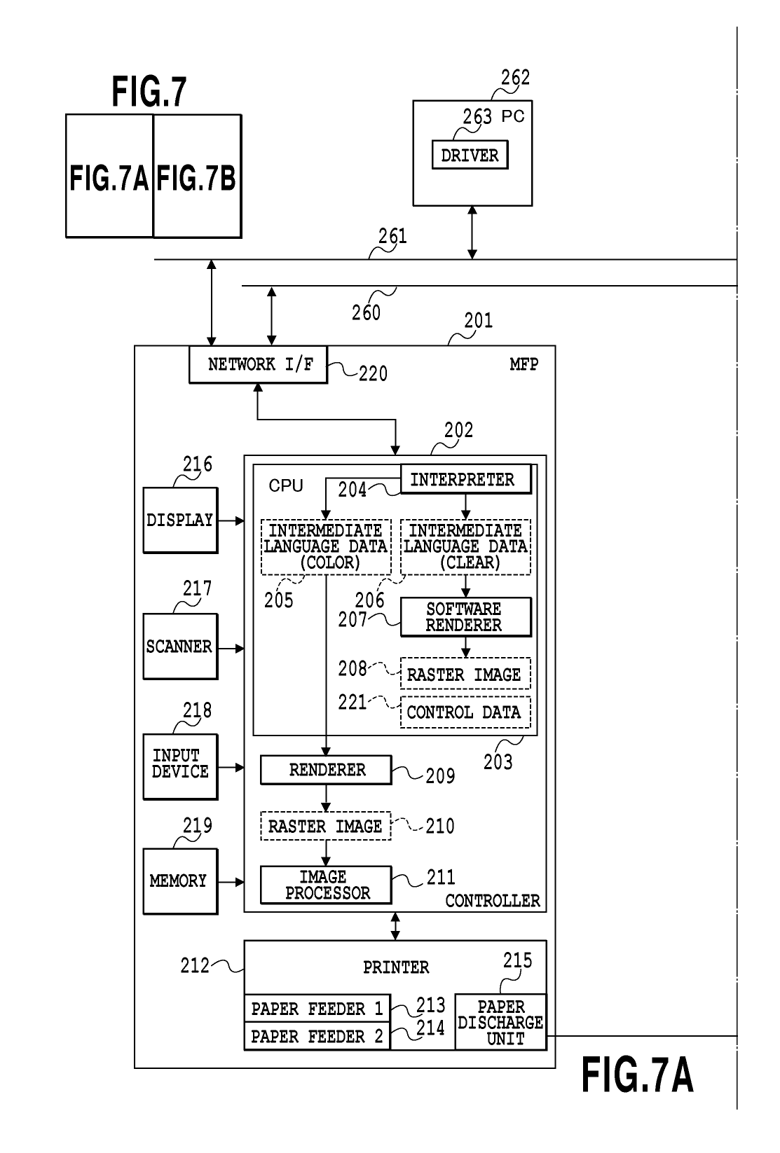

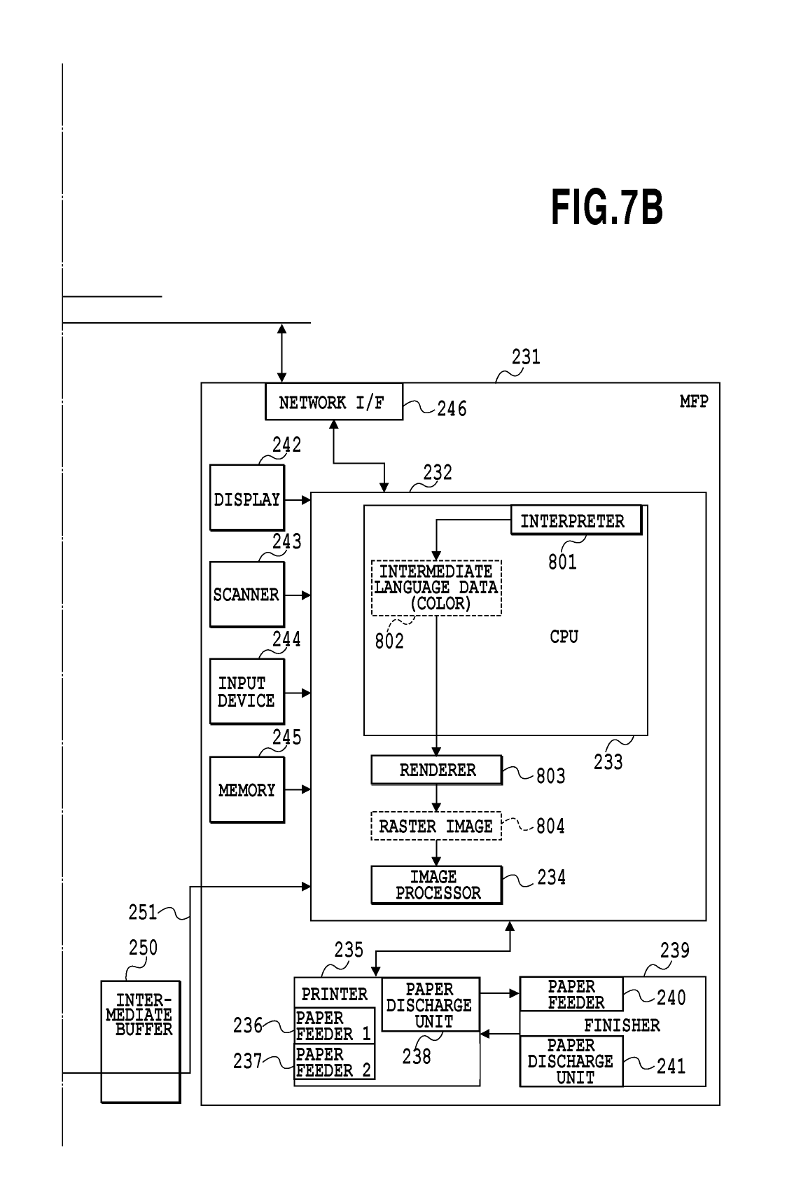

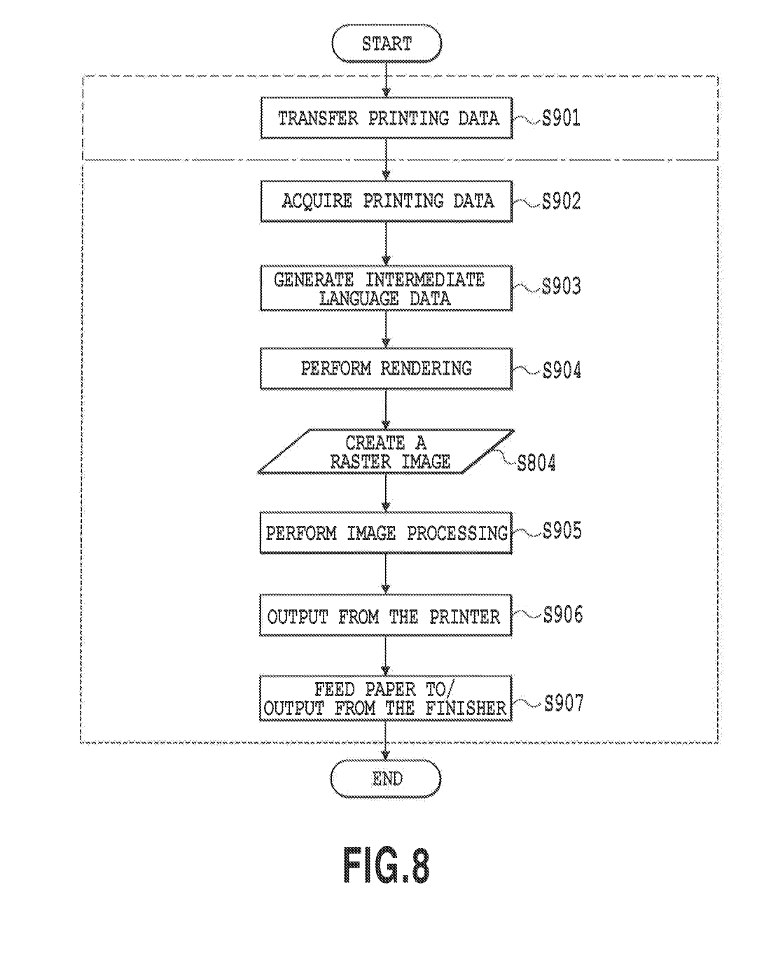

Next, the difference in the configuration and operation when the second MFP 231 continues printing and normal printing will be explained using FIGS. 7A and B and FIG. 8. When printing is not continued, recovery of the paper jam is performed as normal, and the processing explained here is eliminated. The difference from the configuration during normal printing illustrated in FIGS. 2A and B will be explained using FIGS. 7A and B.

The controller 232 has the same construction as that of the first MFP 201, including also a CPU 233 and image processor 234. In special operation when a jam occurs, an interpreter 810 and renderer 803 are also used. The interpreter 801 generates intermediate language data (color/clear) 802. The renderer 803 converts the intermediate language data (color/clear) 802 to a raster image 804.

In normal printing, first the first MFP 201 discharges printing paper on which CMYK color toner has been transferred and fixed. Then the discharged printing paper is fed to the second printer 235 by way of the intermediate buffer. Clear toner is transferred to this printing paper, and by transferring again, printing is completed. However, in the processing of this embodiment, image processing is performed by the image processor 234 so that both printing using CMYK toner and printing using clear toner can be executed by just the second printer 235. The other difference from the normal printing operation is that in normal operation, the printing paper that is discharged from the first MFP 201 is fed to the paper feeder 1_236; however in this process, printing paper is fed from the paper feeder 2_237.

Next, the difference from the operation flow during normal printing illustrated in FIG. 3 will be explained using FIG. 8. The program for the processing in step S901 is stored in the memory 219 of the first MFP 201, is installed in RAM and executed by the CPU 203. Moreover, the program for the processing from step S902 to step S907 is stored in the memory 245 of the second MFP 231, is installed in RAM and executed by the CPU 233.

In step S901, the controller 202 transfers the portion of the printing data that was sent from the PC 262 that is after the jammed page that was not outputted during the inputted job. In other words, when the first MFP 201 is jammed and a continue printing instruction is received by the second MFP 231, the CPU 203 transfers the portion of the printing data for after the jammed page to the controller 232 of the second MFP 231 by way of the network I/F 220.

Next, in step S902, the controller 232 acquires the printing data that is sent from the first MFP 201. In step S903, the interpreter 801 creates intermediate language data 802. Furthermore, in step S904, the renderer 803 performs rendering and creates a raster image 804. In step S905, the image processor 211 executes image processing, and in step S906, the printer 235 feeds paper from the paper feeder 2_237, and using CMYK toner and clear toner, outputs image data onto the printing paper.

From the above, it is possible to continue printing by effectively using the CMYK toner printing function of the second MFP 231 even when a jam occurs in the first MFP 201 and recovery is in progress, and thus it is possible to improve convenience.

Moreover, after a jam occurred in the first MFP 201 above, only the portion of the printing data of the same job for after the jammed page that could not be output is sent to the controller 232 of the second MFP; however, it is also possible to send the printing information for all of the pages of the job beforehand to the controller 232 of the second MFP. In that case, action can be taken quickly when a jam occurs.

(Flow of Operation when a Jam Occurs in the Second MFP 231)

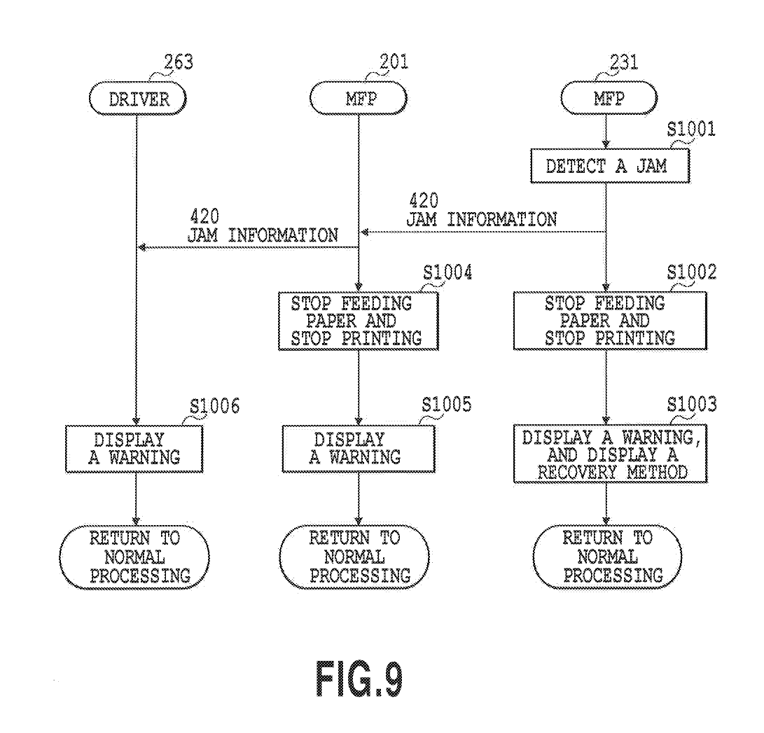

Continuing, FIG. 9 will be used to explain the flow of operation when a jam occurred in the second MFP 231. The program for the processing from step S1001 to step S1003 is stored in the memory 245 of the second MFP 231, installed in RAM and executed by the CPU 233. Moreover, the program for the processing from step S1004 to step S1005 is stored in a memory device 219, installed in RAM and executed by the CPU 203. The program for the processing of step S1006 is stored in a memory device (not illustrated in the figures) of the PC 262, installed in RAM and executed by the driver 263 that is expanded by a CPU (not illustrated in the figures).

In step S1001, a jam in the second MFP 231 is detected by a notification from a jam detection sensor (not illustrated in the figures). The second MFP 231 receives the jam detection, and notifies the first MFP 201 of the jam information 420. The first MFP 201 that received the jam information 420 further notifies the driver 263.

In step S1002, the jam detection is received and the paper feed and printing processes are stopped. In step 1003, by way of the UI of the MFP a warning display and recovery method (location of the paper jam and method for removal) are displayed. In step S1004, the first MFP 201 that received the jam information 420 stops the paper feed and printing processes. A paper jam has not occurred in the first MFP 201, so that stopping the printing processing is performed after advancing to the position where paper does not have to be discarded. Even when the amount of stock in the intermediate buffer 250 is normally kept at a fixed amount, it is possible to temporarily increased the stock amount of the intermediate buffer 250 and perform output from the first MFP 201.

(Flow of Operation when Performing Recovery in the Second MFP 231)

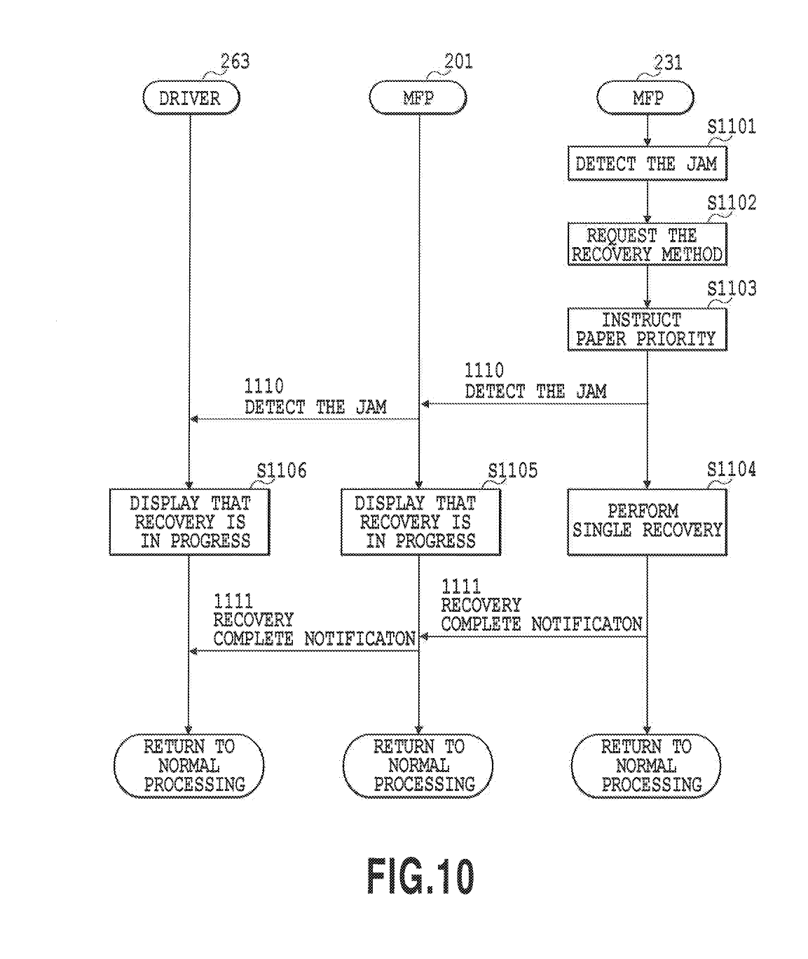

Next, the flow of the recovery operation after the operator has removed the paper that caused the jam in the second MFP 231 will be explained using FIG. 10. The program for the processing from step S1101 to step S1104 is stored in the memory 245 of the second MFP 231, installed in RAM and executed by the CPU 233. The program for the processing of step S1105 is stored in the memory 219 of the first MFP 201, installed in RAM and executed by the CPU 203. Moreover, the program for the processing of step S106 is stored in a memory device (not illustrated in the figures) of the PC 262, installed in RAM and executed by the driver 263 that is expanded by a CPU (not illustrated in the figures).

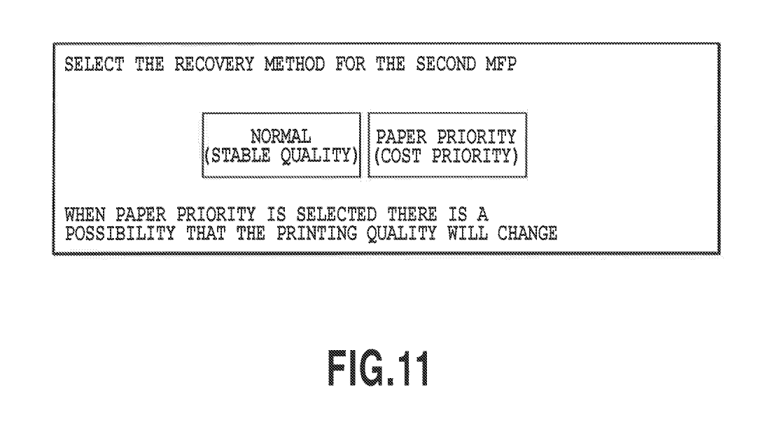

Step S3101 detects from a notification from a jam detection sensor (not illustrated in the figures) that the jammed paper in the second MFP 231 has been removed. In step S1102, the display 242 displays a request to the operator to select the recovery method for the second MFP 231 (as in FIG. 11 for example). Here it is presumed that in step S1103 the input device 244 receives a paper priority (cost priority) instruction from the operator as the recovery method.

Here, as is known in this technical field, when the second MFP 231 executes recovery, which is a feature of this embodiment, printing of CMYK toner and clear toner is then performed by one printer, so the high image quality printing of this printing system is impaired. In other words, when printing of CMYK toner and clear toner is performed by one printer, there is a limit to the amount of toner that can be used, so it is not possible to use a sufficient amount of toner, and there is a possibility that good image quality will not be obtained.

Therefore, by eliminating wasted paper when reprinting on paper that has been printed on in the first MFP, there is a possibility that the printing quality will deteriorate. For example, in a system such as in this embodiment that prints clear toner in a second MFP, the deterioration of image quality when printing using only one MFP will stand out when compared with when printing is performed using two MFP, especially when a large amount of toner is used in the CMYK image. Conversely, when by accident a jam occurred and it became necessary to reprint the image and not much toner is used, the deterioration of image quality does not stand out, so there are cases where selecting to eliminate wasting print paper is preferred. Therefore, in this embodiment, the case of handling recovery of a jam by using only the second MFP is called “Paper Priority (Cost Priority)” recovery. Recovery is the reprinting of pages that were backed up in the device in which a jam occurred at the time the jam occurred, or reprint in a page or pages that caused a jam. On the other hand, the case of performing a normal recovery (reprinting only the necessary pages due to the jam, and performing that printing later using both the first. MFP and second MFP) is called “Normal (Stable Quality)” recovery.

Next, after receiving a paper priority (cost priority) instruction from the operator as the recovery method, the input device 244 sends a recovery start notification 1110 to the first MFP 201. The first MFP 201 receives the recovery start notification 1110 and similarly notifies the river 23. In step S105 and step 1106, the recovery start notification 1110 is received, and the warning display is changed to a display that indicates a waiting state for recovery.

Next, in step S1104 the input device 244 receives a paper priority (cost priority) instruction from the operator and enters the recovery operation. Paper on which first image data has been printed by the first MFP is fed, and when the paper that is inside the second MFP 231 has been removed, the image data that was printed on the removed paper is processed and recovered by the operation explained in FIGS. 7A and B and FIG. 8. In other words, by having the second MFP 231 print on the paper that was fed from the paper feeder 2_237, including the CMYK toner portion that was supposed to have been printed by the first MFP 201, recovery is performed without affecting the first MFP 201. After that, a recovery complete notification 1111 is sent to the first MFP 201, and after receiving the notification, the first MFP 201 similarly notifies the driver 263.

The recovery complete notification 1111 could also be sent after the second MFP 231 has finished outputting the paper in the intermediate buffer 250. That is, the first MFP 201 can be recovered to the normal state after the paper in the intermediate buffer 250 has been reduced. In this embodiment, an example of a paper priority instruction was explained; however, the processing when the operator gives a normal (stable quality) instruction will be simply explained.

After a normal (stable quality) instruction has been received from the operator, the input device 244 performs, recovery by the same operation as conventional recovery. Printing, including the image data that was printed on the paper that was discarded when performing recovery of the jam, and the image data that was printed on the paper in the first MFP 201 and the intermediate buffer 250, is printed again from the first MFP 201. Therefore, the paper that is in the first MFP 201 and in the intermediate buffer 250 must be removed. After that, normal printing is restarted beginning from the pages that had to be removed. In other words, all of the pages are printed using the same normal printing, so the outputted product has stable quality. However, the recovery printing is performed after the job has finished, so the printing order has changed.

By performing recovery using the second MFP 231 using the process described above, paper inside the first MFP 201 does not need to be removed, and it is possible to reduce the amount of time needed for reprinting and the amount of wasted paper that conventionally had to be discarded. Moreover, in this recovery method, the printing method is not changed, so that for the user, recovery can be performed very conveniently.

The operation during a jam was explained as being a recovery operation wherein paper is fed from the paper feeder 2_237 of the second MFP 231; however, in the embodiment, the operation is not limited to this. In other words, as long as the stacked paper can be interrupted and new paper can be fed to the second. MFP 231, paper could also be fed from the intermediate buffer 250 or first MFP 201.

### Embodiment 2

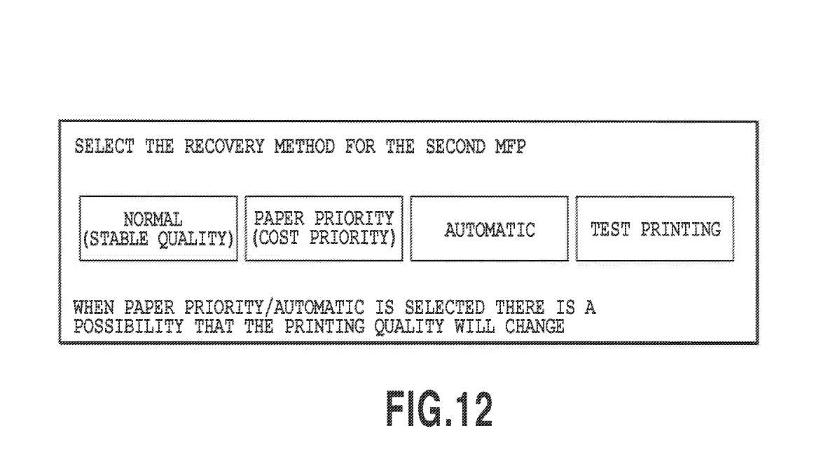

In the first embodiment, as illustrated in FIG. 11, the operator is prompted to select either “Normal (Stable quality)” or “Paper priority (Cost priority)” as the recovery method when performing recovery by the second MFP 231, and recovery is performed based on the selection result. However, when a jam actually occurs and the discarded pages must be recovered, it is often difficult for the operator to determine whether priority should be given to the quality or to the cost. Therefore, in this embodiment, two modes have been provided to assist in determining whether to select “Normal (Stable quality)” or “Paper priority (Cost priority)”. In other words, as illustrated in FIG. 12, these two modes are the “Automatic” mode and “Test Printing” mode. The “Automatic” mode is a setting that automatically determines based on printing data and environmental information whether to select “Normal (Stable quality)” or “Paper priority (Cost priority)” of the first embodiment. On the other hand, the “Test Printing” mode is a setting for assisting the operator when multiple sheets of paper are jammed to make a decision by printing one or two sheets using the paper priority (cost priority) method and looking at the output result.

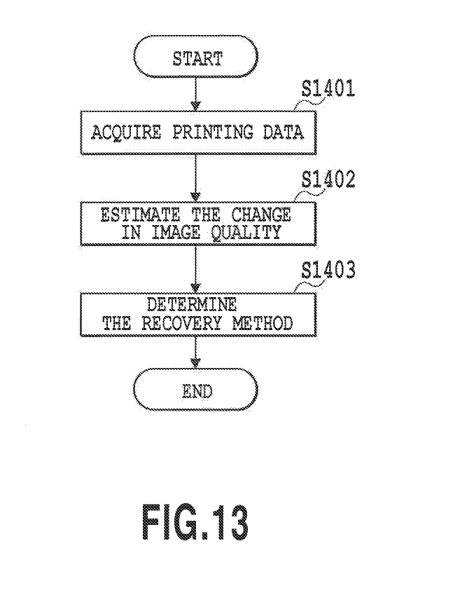

First, the “Automatic” mode will be explained using the operation flowchart illustrated in FIG. 13. The program for the processing from step S1401 to step S1403 is stored in the memory 245 of the second MFP 231, installed in RAM and executed by the CPU 233. The input device 244 receives an instruction from the operator to set the “Automatic” mode and in step S1401 acquires printing data for the recovery printing. In step S1402, when recovery is performed by the paper priority method, from the information of the printing data, printing is compared with normal printing and how much the image quality will change is estimated. Here, the information of the printing data is printing mode information such as monochrome printing, color printing or clear printing, the type of paper and the like, and device information (operating condition information such as temperature and humidity, amount of remaining toner of each color, frequency of use of each drum, and the like); however the information is not limited to this. For example, when the printing data is clear data and paper priority is selected, the amount of toner that can be used to perform both CMYK and clear printing by one printer is limited, so when compared with normal printing, there is a possibility that the image quality will be greatly changed.

Particularly, when a large amount of color data is used on a page, there is a concern that there will be a large change in image quality between normal printing, wherein printing is performed by the second MFP 231 after printing has been performed by the first MFP 201, and printing, wherein printing using both CMYK toner and clear toner is performed by only the second MFP 231. Therefore, the difference in a numerical value for the image quality in the case of normal printing, wherein printing is performed using the first MFP and second MFP, and a numerical value for the image quality in the case of printing in the paper priority method, wherein printing is performed using only the second MFP, is taken to be the estimated value for the change in image quality. When this value is greater than a preset value (threshold value), control is performed so chat paper priority printing is not performed. In other words, in step S1403, the estimation for the change in image quality that was output in step S1402 is received, and which recovery operation method to used is determined. When it is determined that the change in image quality is greater than the threshold value, the “Normal” recover operation is executed, and when the change in image quality is determined to be less than the threshold value, the “Paper Priority” recovery operation is performed.

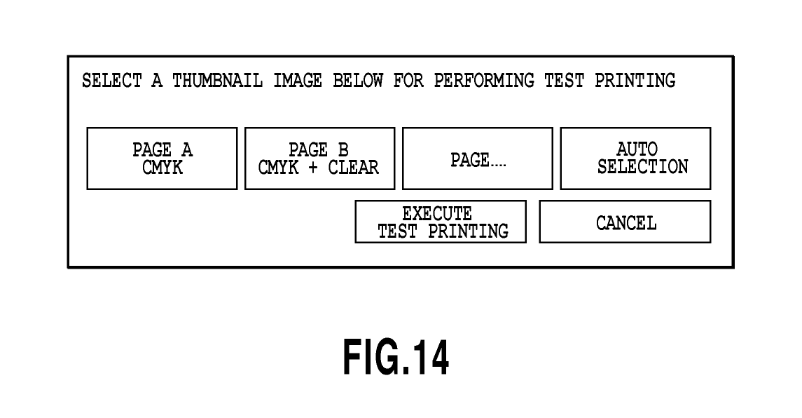

Next, the “Test Printing” mode will be explained. When the input device 244 receives a “Test Printing” instruction, a screen such as illustrated in FIG. 14 is displayed on the display 242. The thumbnail images in FIG. 14 are pages from among the pages that are discarded in order to recover from a jam for which there is a possibility that there will be a change in image quality when recovery printing is performed using the “Paper Priority” method. Thumbnail images of all of the discarded pages do not need to be displayed. It is possible to display only N pages from the start (where N includes 1) or only the pages for which it is estimated there will be a large fluctuation (pages with a large amount of data, pages with a large amount of color or clear, and the like). It is not illustrated in the figures; however, when operator can tell from the thumbnail information which pages do not need to be printed, the operator can cancel execution.

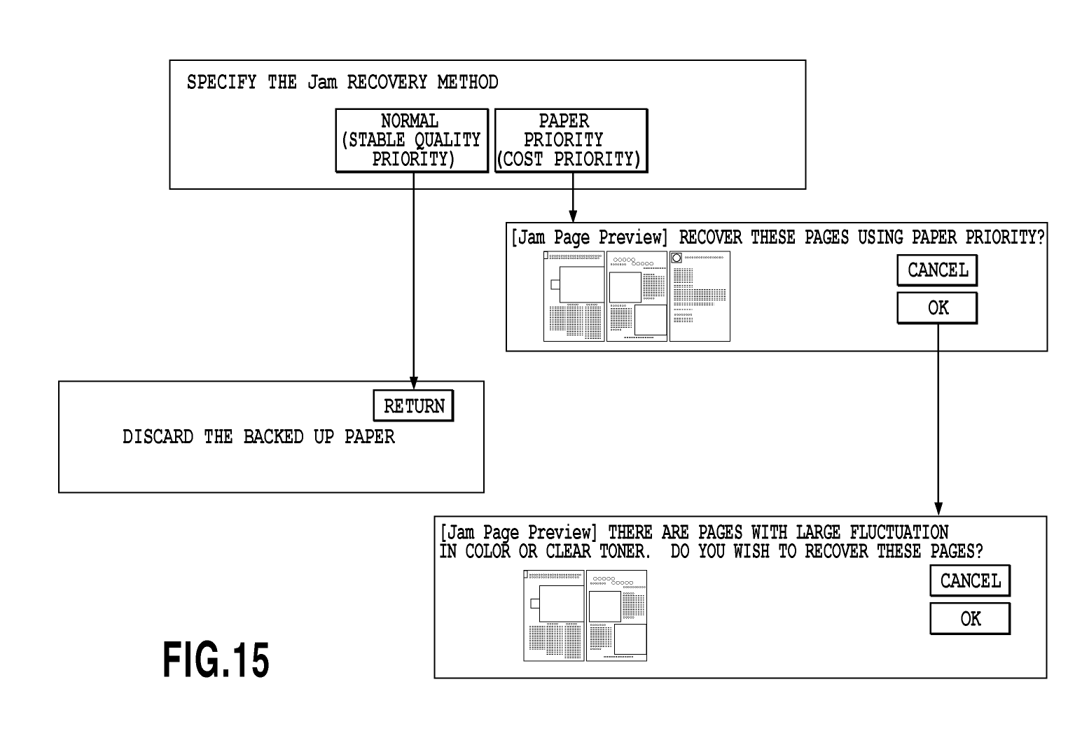

When the operator has specified one or more thumbnail images and the input device 244 has received an instruction to execute test printing, the target pages are printed using the “Paper Priority” method. When printing is performed in the “Test Printing” mode, the printing data is retained and not deleted. After the printing operation, the screen on the display 242 returns to that illustrated in FIG. 12. An example of an actual preview display of the screen illustrated in FIG. 14 is illustrated in FIG. 15.

After the test printing, in the case that the operator again specifies “Paper Priority”, the input device 244 that receives the instruction determines whether or not the pages of the test printing were in sequence from the start of the pages discarded due to the jam, and references the printing setting such as double-sided printing. Whether or not outputted material that has been test printed needs to be reprinted is determined. When it is determined that the printed material does not need to be reprinted, the printing data is deleted, and printing resumes from the next page. When the printing order has changed, or when originally printing was double-sided printing and ended with printing on only one side, printing is performed again.

With the above processing, being assisted by a support function of the device, the operator can determine whether to recover pages that were discarded due to a jam by executing the “Normal (Stable Quality)” method or “Paper Priority (Cost Priority)” method.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer, for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-070246, filed Mar. 28, 2011, which is hereby incorporated by reference herein in its entirety.

1. An image formation system including a first image formation device for forming an image according to first image data of inputted image data using a colored printing agent and a second image formation device forms an image according to second image data of the inputted image data using a transparent printing agent wherein a paper discharge unit of the first image formation device is connected with a first paper feeder of the second image formation device, configured to supply a printing material on which an image was formed by the first image formation device to the second image formation device, the image formation system comprising:
a jam detector for detecting that a jam occurs in the second image formation device; and
an image formation unit for, if the jam detector detects that a jam has occurred in the second image formation device, causing the first image formation device to feed a printing material to the second image formation device from a second paper feeder that is different from the first paper feeder, and causes the second image formation device to form an image according to first image data formed on the printing media upon detecting a jam in the second image formation device, and second image data of the image data, which was inputted together with the first image data, using colored printing agent and transparent printing agent.

2. The image formation system according to claim 1, further comprising
an input device for, if the jam detector detects that a jam has occurred in the second image formation device, prompting the user to determine whether or not to have the second image formation device form an image according to the first image data for an image formed by the first image formation device.

3. The image formation system according to claim 1, wherein the change in image quality upon forming an image by the second image formation device according to the first image data for an image formed by the first image formation device is estimated, and if the estimated change is greater than a predetermined value, the second image formation device does not form an image according to the first image data for an image formed by the first image formation device.

4. The image formation system according to claim 3, wherein the change in image quality is estimated based on the whether the inputted image data is for monochrome printing, color printing or clear printing.

5. The image formation system according to claim 3, wherein the change in image quality is estimated based on whether or not the second image formation device can form an image using CMYK toner and clear toner, and based on the remaining amount of each toner.

6. The image formation system according to claim 1, wherein if the jam detector detects that a jam occurred in the second image formation device, first image data formed on the printing material that was backed up in the second image formation device upon the jam occurrence and second image data inputted together with the first image data are previewed.

7. The image formation system according to claim 6, wherein images are extracted from among the image data and previewed, a change on quality of the images upon printed by the second image formation device being big.

8. The image formation system according to claim 6, further comprising an instruction device for allowing a user, based on the previewed images, to instruct the second image formation device to not form an image according to the first image data for an image formed by the first image formation device, wherein
if the user instructs to not form an image, the second image formation device does not form an image according to the first image data for an image formed by the first image formation device.

9. An image formation system including a first image formation device for forming an image according to first image data of inputted image data using a colored printing agent and a second image formation device forms an image according to second image data of the inputted image data using a transparent printing agent wherein a paper discharge unit of the first image formation device is connected with a first paper feeder of the second image formation device, configured to supply a printing material on which an image was formed by the first image formation device to the second image formation device, the image formation system comprising:
a jam detector for detecting that a jam occurs in the second image formation device, wherein
the first image formation device comprises:
a notification receiver for, if a jam occurred in the second image formation device, receiving a notification that a jam occurred in the second image formation device; and
a halt unit for, if the notification receiver receives a notification that a jam occurred, halting feeding the printing material on which an image was formed by the first image formation device to the second image formation device; and the second image formation device comprises:
an image formation unit for, if a jam occurred in the second image formation device, the printing material for which the jam was detected has been removed and an instruction to form an image according to the first image data after an image of the first image data formed on the printing material upon detecting the jam again has been received, forming an image according to the first image data after the image of the first image data formed on the printing material upon detecting the jam, and according to the second image data, which makes up the image data together with the first image data, using the color printing agent and transparent printing agent.

10. A method for an image formation system including a first image formation device for forming an image according to first image data of inputted image data using a colored printing agent and a second image formation device forms an image according to second image data of the inputted image data using a transparent printing agent wherein a paper discharge unit of the first image formation device is connected with a first paper feeder of the second image formation device, configured to supply a printing material on which an image was formed by the first image formation device to the second image formation device, the method comprising:
detecting that a jam occurs in the second image formation device; and
if it is detected that a jam has occurred in the second image formation device in the detecting, causing the first image formation device to feed a printing material to the second image formation device from a second paper feeder that is different from the first paper feeder, and causes the second image formation device to form an image according to first image data formed on the printing media upon detecting a jam in the second image formation device, and second image data of the image data, which was inputted together with the first image data, using colored printing agent and transparent printing agent.

11. A method for an image formation system including a first image formation device for forming an image according to first image data of inputted image data using a colored printing agent and a second image formation device forms an image according to second image data of the inputted image data using a transparent printing agent wherein a paper discharge unit of the first image formation device is connected with a first paper feeder of the second image formation device, configured to supply a printing material on which an image was formed by the first image formation device to the second image formation device, the method comprising:
detecting that a jam occurs in the second image formation device, wherein
if a jam occurred in the second image formation device, receiving a notification that a jam occurred in the second image formation device in the first image formation device;
if a notification that a jam occurred is received in the first image formation device, halting feeding the printing material on which an image was formed by the first image formation device to the second image formation device; and
if a jam occurred in the second image formation device, the printing material for which the jam was detected has been removed and an instruction to form an image according to the first image data after an image of the first image data formed on the printing material upon detecting the jam again has been received, forming an image according to the first image data after the image of the first image data formed on the printing material upon detecting the jam, and according to the second image data, which makes up the image data together with the first image data, using the color printing agent and transparent printing agent in the second image formation device.

12. A recording medium that stores programs for causing a computer to execute a method for an image formation system including a first image formation device for forming an image according to first image data of inputted image data using a colored printing agent and a second image formation device forms an image according to second image data of the inputted image data using a transparent printing agent wherein a paper discharge unit of the first image formation device is connected with a first paper feeder of the second image formation device, configured to supply a printing material on which an image was formed by the first image formation device to the second image formation device, the method comprising:
detecting that a jam occurs in the second image formation device; and
if it is detected that a jam has occurred in the second image formation device in the detecting, causing the first image formation device to feed a printing material to the second image formation device from a second paper feeder that is different from the first paper feeder, and causes the second image formation device to form an image according to first image data formed on the printing media upon detecting a jam in the second image formation device, and second image data of the image data, which was inputted together with the first image data, using colored printing agent and transparent printing agent.

13. A recording medium that stores programs for causing a computer to execute a method for an image formation system including a first image formation device for forming an image according to first image data of inputted image data using a colored printing agent and a second image formation device forms an image according to second image data of the inputted image data using a transparent printing agent wherein a paper discharge unit of the first image formation device is connected with a first paper feeder of the second image formation device, configured to supply a printing material on which an image was formed by the first image formation device to the second image formation device, the method comprising:
detecting that a jam occurs in the second image formation device, wherein
if a jam occurred in the second image formation device, receiving a notification that a jam occurred in the second image formation device in the first image formation device;
if a notification that a jam occurred is received in the first image formation device, halting feeding the printing material on which an image was formed by the first image formation device to the second image formation device; and
if a jam occurred in the second image formation device, the printing material for which the jam was detected has been removed and an instruction to form an image according to the first image data after an image of the first image data formed on the printing material upon detecting the jam again has been received, forming an image according to the first image data after the image of the first image data formed on the printing material upon detecting the jam, and according to the second image data, which makes up the image data together with the first image data, using the color printing agent and transparent printing agent in the second image formation device.
